(19) United States
(12) Patent Application Publication
(10) Pub. No.: US 2026/0026998 A1
(43) Pub. Date: Jan. 29, 2026

(54) FACE MASSAGER

(71) Applicant: PEOPLE PIE CO., LTD., Seoul (KR)

(72) Inventor: Wang Ki KIM, Seoul (KR)

(73) Assignee: PEOPLE PIE CO., LTD., Seoul (KR)

(21) Appl. No.: 18/784,811

(22) Filed: Jul. 25, 2024

(51) Int. Cl. A61H 15/00

(52) U.S. Cl. CPC A61H 15/0085; A61H 2015/0014; A61H 2015/0042; A61H 2201/1215; A61H 2201/1695; A61H 2205/022

(57) ABSTRACT

The present invention relates to a face massager, and more specifically, to a face massager capable of maximizing the massage effect by rotating a roller in place by a motor and causing protrusions formed on the roller to intensively hit a local site of the facial skin.

### FIELD

The present invention relates to a face massager, and more specifically, to a face massager capable of maximizing the massage effect by rotating a roller in place by a motor and causing protrusions formed on the roller to intensively hit a local site of the facial skin.

### BACKGROUND OF THE INVENTION

In recent years, as interest in beauty has increased, various types of massagers are being developed. In particular, face massagers are preferred by consumers since the face massagers have the effect of reducing the size of the face by applying pressure to the facial skin.

FIG. 9 is a photograph of an actual product of a face massager in the conventional art. As the general shape of the face massager in the related art, a grippable bar is coupled to a pair of fixed balls at an end of the bar, as shown in FIG. 9. In addition, the face massager is used in a way that a user grips the bar and brings the pair of balls into contact with the face, and then manually moves the gripped bar in a reciprocating manner so that the balls apply pressure to the entire facial skin.

In addition, as an improved product of the face massager in the related art, a face massager in which a rotating shaft is formed at an end of a bar and a ball is coupled to the rotating shaft has been developed. The improved product has the effect of improving convenience by allowing the ball to rotate in response when a user manually moves the bar gripped by the user in a reciprocating manner.

However, face massagers in the related art have the following problems. Regardless of whether the face massager is a pre-improved product or a post-improved product, when the user grips the bar and moves the bar in a reciprocating manner, since the ball coupled to the bar has to move in a reciprocating motion in response, a contact site where the facial skin comes into contact with the ball becomes relatively wide, but there is a problem that the effect of pressing the skin is minimal since it is difficult to apply intensive pressure to a local site.

In addition, in order to increase the pressure effect, there is a method in which the user directly applies pressure by placing the ball on the local site and applying force, but the method has a problem in that the user's ease of use is significantly reduced and the user's fatigue increases due to continuous force on the arm.

### SUMMARY OF THE INVENTION

The present invention relates to a face massager, and more specifically, to a face massager capable of maximizing the massage effect by rotating a roller in place by a motor and causing protrusions formed on the roller to intensively hit a local site of the facial skin.

According to an aspect of the present invention, there is provided a face massager including a main body including a portion formed to be gripped by a user, a support branched from an upper portion of the main body to be spaced apart at a predetermined distance, and a roller that is accommodated in the support and is rotatable, in which a plurality of protrusions are formed on the roller.

In addition, according to the present invention, each of the protrusions may be formed to extend in a longitudinal direction of the roller and protrudes from an outer surface of the roller.

In addition, according to the present invention, the plurality of protrusions may be formed to be spaced apart at a predetermined distance in a width direction of the roller.

In addition, according to the present invention, a groove curved toward a center of the roller may be formed between a pair of adjacent protrusions.

In addition, according to the present invention, an end of the protrusion may be rounded.

In addition, according to the present invention, the roller may be detachably coupled to the support.

In addition, according to the present invention, a surface of the roller may be made of silicone.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows a face massager according to the present invention;

FIG. 2 shows a main body and a support of the face massager according to the present invention;

FIG. 3 shows a roller of the face massager according to the present invention;

FIG. 4 shows an appearance of the roller of the face massager according to the present invention as seen from the side;

FIG. 5 shows the interior of the main body and the support of the face massager according to the present invention;

FIG. 6 shows a configuration of a removal portion inside the main body and the support of the face massager according to the present invention;

FIG. 7 is an enlarged view of the vicinity of a first support hole of the face massager according to the present invention;

FIG. 8 is an enlarged view of the vicinity of a second support hole of the face massager according to the present invention; and

FIG. 9 is a photograph of an actual product of a face massager in the related art.

### DETAILED DESCRIPTION OF EXEMPLARY EMBODIMENTS

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The device, apparatus and methods described herein should not be construed as limiting in any way. Instead, the present disclosure is directed toward all novel and non-obvious features and aspects of the various disclosed embodiments, alone and in various combinations and sub-combinations with one another. The disclosed devices, methods, and apparatus are not limited to any specific aspect or feature or combinations thereof, nor do the disclosed devices, methods, and apparatus require that any one or more specific advantages be present or problems be solved. Any theories of operation are to facilitate explanation, but the disclosed devices, methods, and apparatus are not limited to such theories of operation.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

Hereinafter, one embodiment of a face massager according to the present invention will be described in detail with reference to the accompanying drawings. In the process, thicknesses of lines, dimensions of elements, and the like shown in the drawings may be exaggerated for clarity and convenience. Also, terms described below may be defined in consideration of functions in the present disclosure, and may be changed depending on the customary practice or the intention of a user or operator. Thus, definitions of such terms should be determined based on the overall content of the present specification.

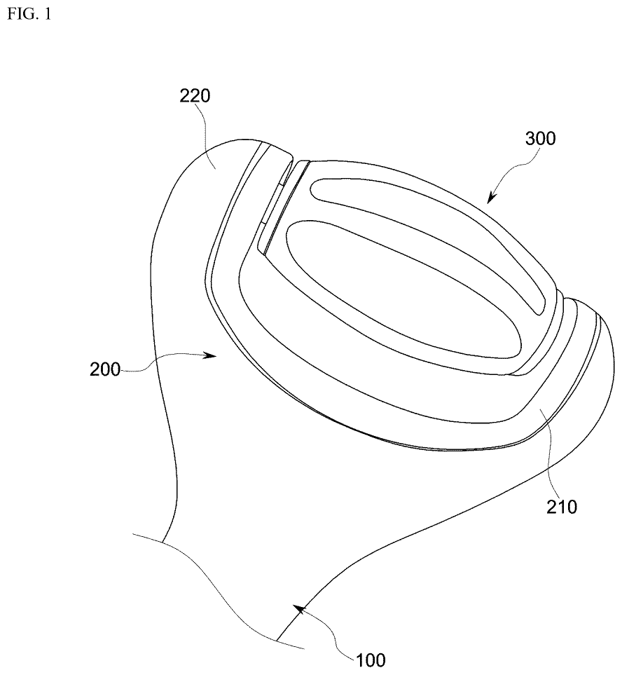

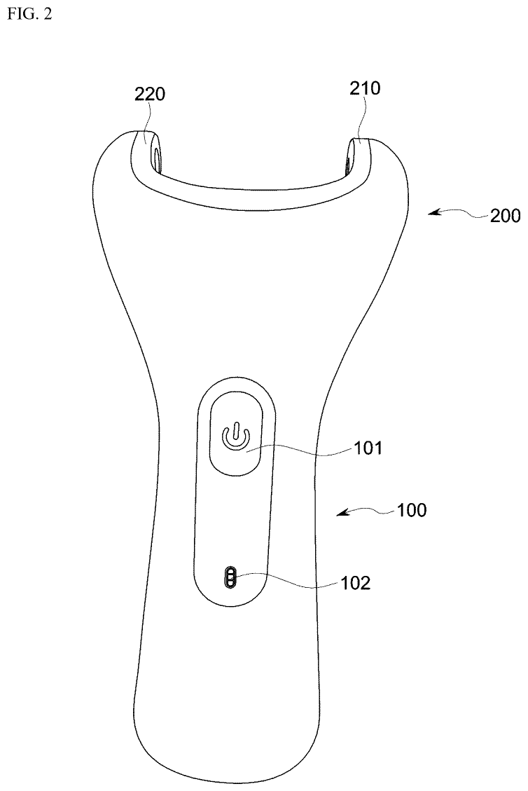

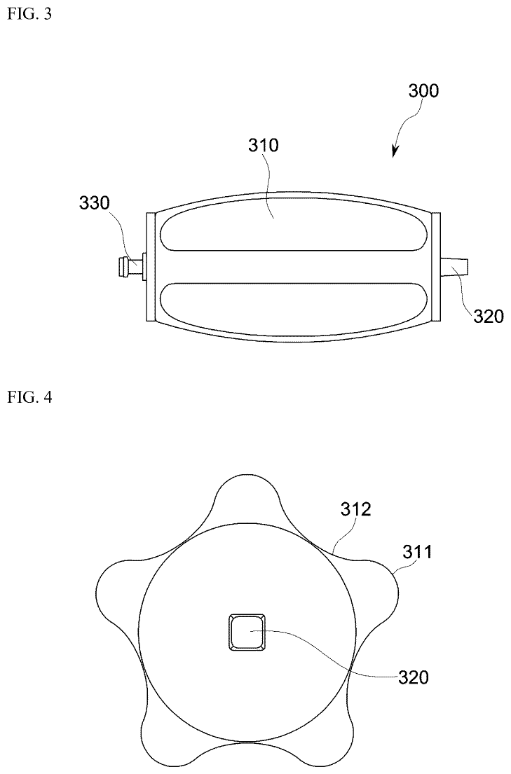

FIG. 1 shows a face massager according to the present invention, FIG. 2 shows a main body and a support of the face massager according to the present invention, and FIG. 3 shows a roller of the face massager according to the present invention. Hereinafter, the configuration and effect of the face massager according to the present invention will be described with reference to FIGS. 1 to 3.

The face massager according to the present invention includes a main body 100, a support 200, and a roller 300.

The main body 100 is preferably formed to extend in a vertical direction so that the user may grip the main body. A battery (not shown) is built into the main body 100, and through this, the battery is linked with a motor 400, which will be described below, inside the main body 100, so that the power of the motor 400 is transferred to the roller 300. In this way, the roller 300 is capable of being rotated without a user having to manually move a bar (corresponding to the main body 100 of the present invention) as in the related art, and a pressure may be effectively applied to a local site. A description thereof will be given in detail below.

In addition, a charging terminal (not shown) is built-in and partially protrudes, and since the battery may be charged through the charging terminal, there is an advantage of maximizing ease of use.

Referring to FIG. 2, it is preferable that a power button 101 and a lighting device 102 are formed on a surface of the main body 100. The driving of the motor 400 may be turned on/off through the power button 101, and through the motor, the rotation of the roller 300 may be turned on/off. In addition, it is preferable that a plurality of lighting devices 102 are formed so that the battery capacity of the currently installed battery may be displayed.

It is preferable that the support 200 has a shape of being branched from an upper portion of the main body 100 to be spaced apart. More specifically, the support 200 includes a first support 210 and a second support 220, the first support 210 and the second support 220 are spaced apart at a predetermined distance in a longitudinal direction, and a third support 230 connecting the first support 210 and the second support 220 is formed. Accordingly, the first support 210, the second support 220, and the third support 230 form one hollow portion, and the roller 300 may be accommodated in the hollow portion.

A first support hole 211 and a second support hole 221 are formed in the first support 210 and the second support 220, respectively, and it is preferable that the first support hole 211 and the second support hole 221 are formed to face each other. A description thereof will be given below.

The roller 300 will be described with reference to FIG. 3.

The roller 300 is accommodated in the support 200 and is detachably coupled. More specifically, it is preferable that the roller 300 is inserted into the hollow portion formed by the first support 210, the second support 220, and the third support 230.

It is preferable that the roller 300 includes a body portion 310, a first connector portion 320, and a second connector portion 330. The body portion 310 is preferably formed to extend in the longitudinal direction, and the first connector portion 320 and the second connector portion 330 are formed to protrude from both ends of the body portion 310 in the longitudinal direction, respectively. As will be described below, the first connector portion 320 is inserted into the first support hole 211, and the second connector portion 330 is inserted into the second support hole 221.

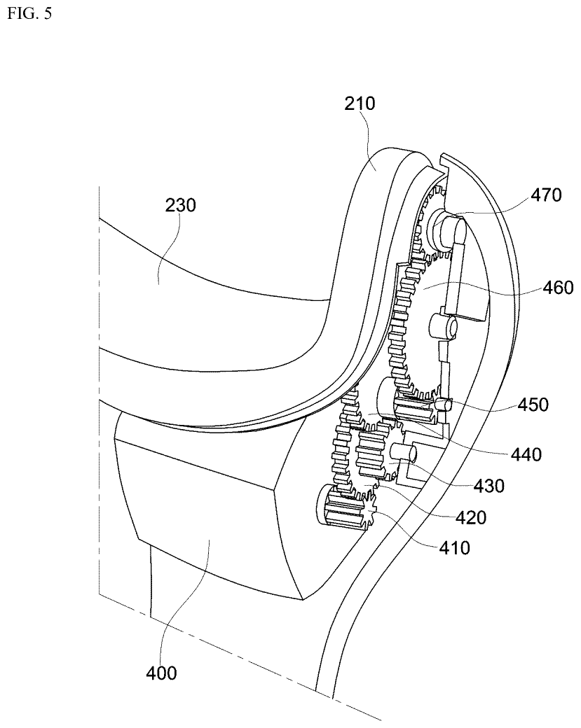

FIG. 4 shows an appearance of the roller according to the present invention as seen from the side. Hereinafter, with reference to FIG. 4, the configuration of the body portion 310 of the roller 300 according to the present invention will be described in detail.

It is preferable that a protrusion 311 is formed on an outer surface of the body portion 310. The protrusion 311 preferably has a shape that protrudes from the center of the body portion 310 toward the outer surface and is formed to extend in the longitudinal direction. In addition, it is preferable that a plurality of protrusions 311 are formed, and it is preferable that the protrusions are formed to be spaced apart at a predetermined distance in a width direction along the outer surface of the body portion 310. For example, it is preferable that five protrusions 311 are formed.

As described above, due to the shape of the protrusion 311 protruding from the center of the body portion 310 toward the outer surface, a structure in which the protrusion portion may press the facial skin is formed. In this case, as will be described below, a position of the main body 100 is fixed, and as the roller 300 rotates in place by the motor 400, when the roller 300 comes into contact with the facial skin, the plurality of protrusions 311 continuously apply pressure to the corresponding local site at predetermined time intervals.

Therefore, unlike the related art, as the roller 300 rotates in place, the protrusions 311 may continuously apply pressure to the local site, and as the pressure of the protrusions 311 on the local site accumulates, the effect of applying deep pressure from the surface of the facial skin toward the inside of the skin is exhibited. Thereby, there is an advantage of increasing the pressure effect on the local site, thereby maximizing the efficiency of face massage.

In this case, damage to the skin surface may occur as the protrusions 311 continuously rub against the local site of the skin surface, and since resistance opposite to a rotational direction of the roller 300 continues to occur, a load may be generated on the motor 400. Therefore, in order to reduce the load of the motor 400 by minimizing the resistance when rotating the roller 300 while maintaining the pressure effect on the local site, an end of the protrusion 311 is preferably rounded, and the protrusion 311 is preferably entirely rounded along the longitudinal direction.

In addition, a groove 312 is formed between a pair of adjacent protrusions 311. In this case, the groove 312 is preferably formed to extend in the longitudinal direction and is preferably curved toward the center of the roller 300.

When the protrusion 311 rotates, a pair of adjacent protrusions 311 may also contact the skin surface. In this case, since pressure is not applied to the local site through a space between the pair of protrusions 311, it is preferable to minimize contact with the skin surface when the roller 300 rotates.

Therefore, in the present invention, the corresponding space is referred to as the groove 312, and may have a shape that is curved (like rounded) toward the center of the roller 300 as shown in FIG. 4, thereby minimizing the contact with the skin surface when the roller 300 rotates to prevent skin damage and minimizing the load applied to the motor 400 to improve product lifespan.

It is preferable that the outer surface of the body portion 310 according to the present invention is made of silicone. Since silicone is a soft material, silicone has the effect of minimizing skin irritation when silicone comes into contact with the skin surface. In addition, since silicone is a somewhat slippery material, silicone has the advantage of minimizing resistance when rubbing against the skin surface and through the minimizing, minimizing the load applied to the motor 400 during the rotation of the roller 300.

FIG. 5 shows the interior of the main body and the support according to the present invention. Hereinafter, with reference to FIG. 5, a coupling configuration and power transmission structure of the motor 400 and the roller 300 will be described.

It is preferable that the motor 400 according to the present invention is built into the main body 100 and the support 200. More specifically, it is preferable that the motor 400 is located at a connection point between a lower portion of the support 200 and an upper portion of the main body 100.

As described above, the motor 400 is linked to the battery (not shown) and may be turned on/off through the power button 101.

It is preferable that the motor 400 is a general power motor, and it is preferable that the motor 400 engages with a plurality of gears.

Referring to FIG. 5, a rotating shaft of the main body of the motor 400 is interlocked with a first gear 410, the first gear 410 engages with a second gear 420 among the second gear 420 and a third gear 430 that share one rotating shaft, the third gear 430 engages with a fourth gear 440 among the fourth gear 440 and a fifth gear 450 that are located above the third gear 430 and share one rotating shaft, the fifth gear 450 engages with a sixth gear 460 located above the fifth gear 450, and the sixth gear 460 engages with a seventh gear 470 located above the sixth gear 460.

To summarize, the power generated from the main body of the motor 400 is sequentially transmitted from the first gear 410 to the seventh gear 470, and has a total of five stages of power transmission structure. Since the space occupied by the gears inside the support 200 may be minimized in this way, there is the advantage of miniaturizing the entire product. As one example, the structure has been described as engaging up to the seventh gear 470, but the number of gears may be increased or decreased as needed.

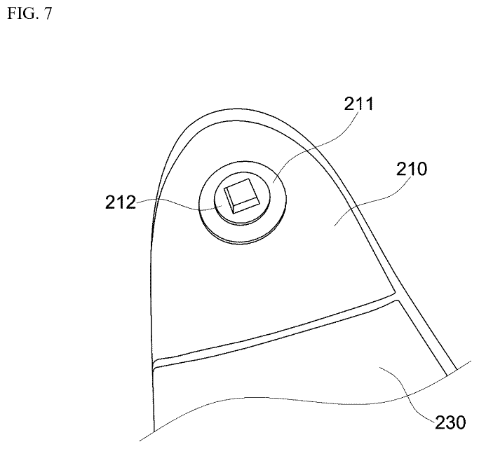

FIG. 7 is an enlarged view of the vicinity of the first support hole of the face massager according to the present invention. Hereinafter, with reference to FIG. 7, a structure in which power generated from the motor 400 of the face massager according to the present invention is transmitted to the roller 300 will be described.

As described above, the first support hole 211 is formed in the first support 210. In this case, it is preferable that a support groove 212 is accommodated inside the first support hole 211.

In this case, one side of the support groove 212 is open as shown in FIG. 7, and the other side of the support groove 212 is preferably coupled to a central shaft of the seventh gear 470 described above. Accordingly, as the seventh gear 470 rotates, the support groove 212 also rotates inside the first support hole 211.

In this case, it is preferable that the support groove 212 has a shape that accommodates the first connector portion 320, and more specifically, it is preferable that the support groove 212 and the first connector portion 320 are capable of male-female coupling. That is, the protruding shape of the first connector portion 320 is accommodated in the support groove 212. Due to the shape, as the support groove 212 rotates, the first connector portion 320 also rotates, and the entire roller 300 connected to the first connector portion 320 rotates.

To comprehensively summarize, the power generated from the motor 400 is transmitted from the first gear 410 to the seventh gear 470, and then transmitted to the entire roller 300 through the support groove 212 and the first connector portion 320. In addition, due to the shape as described above, the roller 300 produces an effect as if the roller rotates in place about a virtual central axis extending from the support groove 212 in the longitudinal direction.

Therefore, due to the effect as described above, all the protrusions 311 may be brought into contact with the same local site, and the local site may be repeatedly hit at predetermined time intervals. In addition, the effect of repeated hitting on the local site generates a deep pressing effect, unlike the related art.

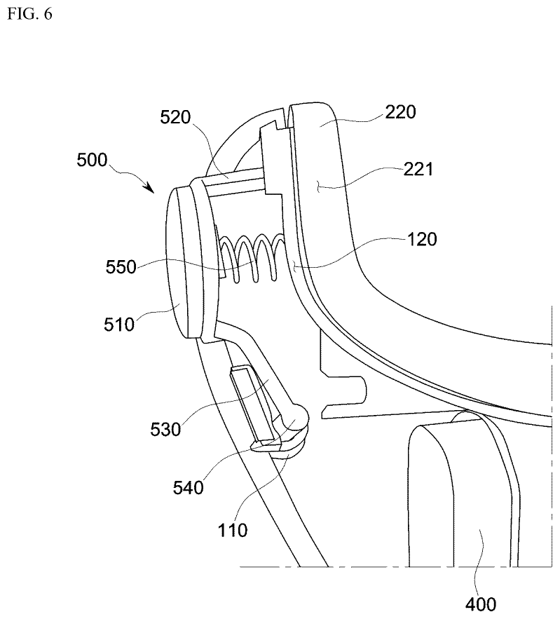

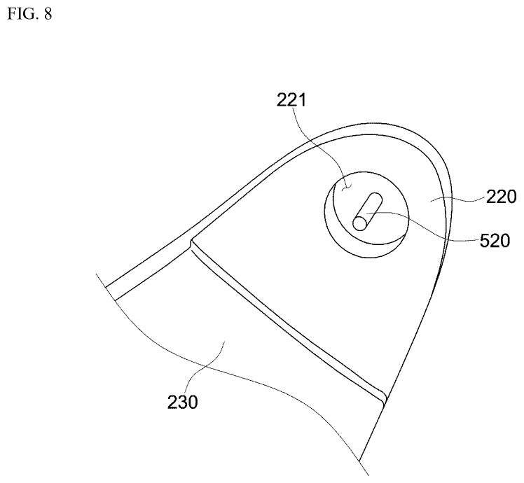

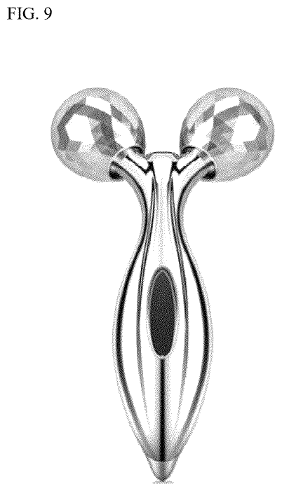

FIG. 6 shows a configuration of a removal portion inside the main body and the support of the face massager according to the present invention, and FIG. 8 is an enlarged view of the vicinity of a second support hole of the face massager according to the present invention. Hereinafter, with reference to FIGS. 6 and 8, the structure for attaching and detaching the roller of the face massager according to the present invention will be described.

First, reference is made to FIG. 6. As described above, a configuration of a plurality of gears of the motor 400 are included near the first support hole 211 of the face massager according to the present invention, and on the contrary, a configuration of a removal portion 500 is included near the second support hole 221.

The removal portion 500 includes a pressing portion 510, a first frame portion 520, a second frame portion 530, a third frame portion 540, and an elastic portion 550.

It is preferable that the pressing portion 510 has a panel shape, and it is preferable that the surface is exposed to the outside of the support 200 so that the user may apply pressure.

The first frame portion 520 extends from the inside of the pressing portion 510 and preferably has a pin shape. In this case, referring to FIG. 8, one end of the first frame portion 520 may pass through the second support hole 221, and the other end of the first frame portion 520 is connected to the pressing portion 510. The effect of the first frame portion 520 will be described below.

The second frame portion 530 is formed to extend from the inside of the pressing portion 510, and it is preferable that the third frame portion 540 is formed to extend from an end of the second frame portion 530 to be perpendicular to the second frame portion 530.

In this case, it is preferable that the support 200 is provided with a connection groove 110 that protrudes inward and accommodates an end of the third frame portion 540. The structure allows the pressing portion 510 to move in a reciprocating motion in a state in which the second frame portion 530 and the third frame portion 540 are supported to be tiltable about the connection groove 110, so that there is the effect of preventing the pressing portion 510 from being separated.

In this case, it is preferable that the elastic portion 550 is coupled to the inside of the pressing portion 510, and it is preferable that one end of the elastic portion 550 is connected to the pressing portion 510 and the other end is coupled to one point inside the support 200. More specifically, it is preferable that the other end is coupled to one point inside the second support 220.

It is preferable that the elastic portion 550 is, for example, a spring capable of contracting and relaxing. Therefore, when the user presses the pressing portion 510, the elastic portion 550 contracts, and when the pressing portion 510 is no longer pressed, the elastic portion 550 relaxes and the pressing portion 510 returns to its original position due to an elastic restoring force.

In this case, referring to FIG. 3, unlike the first connector portion 320, it is preferable that the second connector portion 330 is movable in the longitudinal direction, and when the second connector portion 330 is pressed with external pressure, it is preferable that the second connector portion 330 is temporarily accommodated inside the body portion 310 of the roller 300, and when pressure is not applied to the second connector portion 330, it is preferable that the second connector portion 330 returns to its original position. As one example, a spring is formed inside the body portion 310, and the spring is preferably coupled to an end of the second connector portion 330.

Therefore, due to the structure as described above, the roller 300 is coupled to the support 200 in a detachable structure. Assuming that the roller 300 is separated from the support 200, a process of coupling the roller 300 to the support 200 will be described.

The roller 300 is positioned near the hollow portion formed by the support 200, and the roller 300 is tilted so that the first connector portion 320 is coupled to the support groove 212 inside the first support hole 211. Then, the user presses the second connector portion 330 toward the center of the body portion 310 of the roller 300 to move the second connector portion 330 into the body portion 310, and then aligns the entire roller 300 in parallel to position the end of the second connector portion 330 near the second support hole 221.

Then, when the user no longer presses the second connector portion 330, the second connector portion 330 protrudes from the body portion 310 again due to an elastic restoring force, and at this time, the protruding second connector portion 330 is inserted into the second support hole 221. That is, the rotation of the roller 300 is performed by the first connector portion 320 and the support groove 212, and the second connector portion 330 serves to support the rotation of the roller 300, and at the same time, serves to couple and remove the roller 300 to and from the support 200.

In this case, when the user presses the pressing portion 510 described above, the first frame portion 520 linked to the pressing portion 510 passes through the second support hole 221 and at the same time, moves toward the roller 300. Thereby, the first frame portion 520 presses the second connector portion 330, and in response to the movement of the first frame portion 520 in the longitudinal direction, the second connector portion 330 also moves in the longitudinal direction and moves back into the body portion 310. As a result, the second connector portion 330 is separated from the second support hole 221, thereby allowing the entire roller 300 to be separated from the support 200.

As described above, the roller 300 may be easily replaced by the user's simple operation of pressing the pressing portion 510, so that ease of use may be increased and shapes of various rollers 300 may be modularized to be replaceable according to the user's needs.

Finally, when the user no longer applies force to the pressing portion 510, due to the elastic restoring force of the elastic portion 550, the pressing portion 510 returns to its original position without any external force, so that there is an advantage of maximizing ease of use.

According to another embodiment of the present invention, it is preferable that a coating layer for corrosion prevention is formed on an outer surface of the main body 100.

When continuously performing face massage through the present invention, corrosion and wear of the main body 100 may occur due to moisture on the skin surface.

The coating layer is more specifically an anti-corrosion coating layer, and is intended to prevent corrosion problems of the inner surface of the main body 100 that may occur due to long-term use.

Specifically, the coating layer is coated with an anti-corrosion coating composition, and the anti-corrosion coating composition may include a solvent, a curing agent, and a dispersant.

As the solvent, water (cold water, hot water), alcohol, anhydrous or hydrous lower alcohols having 1 to 4 carbon atoms (methanol, ethanol, alcohol, propanol, butanol, or the like), toluene, phenol, and a mixed solvent of the alcohol and water, or the like, may be used, but are not limited thereto.

Meanwhile, the curing agent serves to improve film properties of the coating layer by shortening a reaction time, and may be an isocyanate resin, but is not limited thereto.

Preferably, as the curing agent, one or more may be selected and used among diphenylmethane diisocyanate, p-toluenesulfonyl isocyanate, 2,4-toluene diisocyanate, diphenylmethane-4,4′-diisocyanate, xylene diisocyanate, and hexamethylene diisocyanate.

The dispersant serves to improve a storage stability of the coating agent by increasing an interfacial area by increasing the dispersibility of various mixtures, and as the dispersant, one may be selected and used among alkali metal silicate and magnesium silicate, but it is preferable to use magnesium silicate.

Meanwhile, the anti-corrosion coating composition may further contain other additives.

The types of other additives may include polysiloxane, epoxy resin, and the like, but are not limited thereto as long as the additive is within a range capable of being employed by those skilled in the art as a composition of the coating composition for preventing corrosion.

Preferably, the anti-corrosion coating composition may further contain a compound represented by Formula 1 below and a compound represented by Formula 2 below:

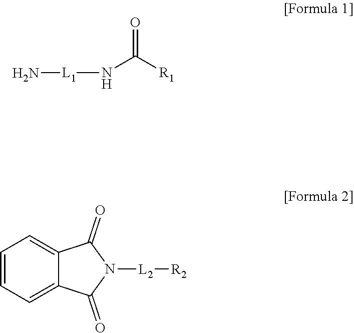

Here, R1 and R2 are the same or different from each other, and are each independently selected from the group consisting of hydrogen, a nitro group, a halogen group, a hydroxy group, a carboxyl group, a substituted or unsubstituted alkyl group having 1 to 30 carbon atoms, a substituted or unsubstituted alkenyl group having 2 to 30 carbon atoms, a substituted or unsubstituted alkynyl group having 2 to 24 carbon atoms, a substituted or unsubstituted aryl group having 6 to 30 carbon atoms, and a substituted or unsubstituted alkoxy group having 1 to 30 carbon atoms,
L1 and L2 are the same or different from each other, and are each independently selected from the group consisting of a single bond, a substituted or unsubstituted alkylene group having 1 to 20 carbon atoms, and a substituted or unsubstituted alkenylene group having 2 to 20 carbon atoms, and
when R1, R2, L1, and L2 are substituted, R1, R2, L1, and L2 are substituted with a substituent selected from the group consisting of hydrogen, a cyano group, a nitro group, a halogen group, a hydroxy group, a carboxyl group, an alkoxy group having 1 to 10 carbon atoms, an alkyl group having 1 to 30 carbon atoms, an alkenyl group having 2 to 30 carbon atoms, and an alkynyl group having 2 to 24 carbon atoms, and when R1, R2, L1, and L2 are substituted with a plurality of substituents, R1, R2, L1, and L2 are the same or different from each other.

When the anti-corrosion coating composition additionally contains the compound represented by Formula 1 and the compound represented by Formula 2, due to a synergistic effect according to the mixing of each active ingredient, there is an effect of not only further improving the anti-corrosion effect, but also maximizing the adhesion of the coating layer to the inner surface of the main body 100.

Specifically, the compound represented by Formula 1 may be a compound represented by Formula 3 below, and the compound represented by Formula 2 may be a compound represented by Formula 4 below:

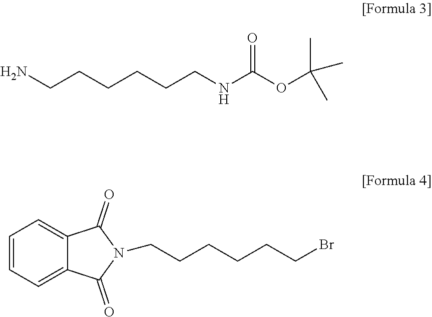 [SMILES: CC(C)(C)OC(=O)NCCCCCCN ; O=C1c2ccccc2C(=O)N1CCCCCCBr]

More preferably, the anti-corrosion coating composition may contain 20 to 40 parts by weight of the curing agent, 20 to 40 parts by weight of the dispersant, 10 to 20 parts by weight of the compound represented by Formula 3, and 10 to 20 parts by weight of the compound represented by Formula 4, relative to 100 parts of weight of the sol vent.

In the case of the weight range described above, due to the synergistic effect according to the mixing of each ingredient, not only may the corrosion prevention effect be maximized, but also the adhesion of the coating layer may be maximized. However, when the anti-corrosion coating composition is mixed below the weight range described above or above the weight range, the effect may be minimal.

### Preparing Example

An anti-corrosion coating composition was prepared by mixing a curing agent (diphenylmethane diisocyanate), a dispersant (magnesium silicate), a compound represented by Formula 3 below, and a compound represented by Formula 4 below in toluene, which is a solvent for preparing a coating composition, in a weight range shown in Table 1 below, and stirring the mixture for two hours while maintaining the temperature at 75° C.

Meanwhile, the compounds were purchased and used from Tokyo chemical industry CO., LTD:

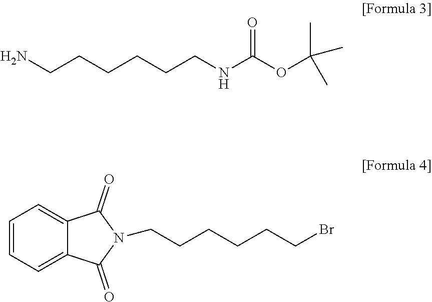 [SMILES: CC(C)(C)OC(=O)NCCCCCCN ; O=C1c2ccccc2C(=O)N1CCCCCCBr]

TABLE 1

| | T1 | T2 | T3 | T4 | T5 | T6 |
|---|---|---|---|---|---|---|
| Solvent | 100 | 100 | 100 | 100 | 100 | 100 |
| Curing agent | 30 | 15 | 20 | 30 | 40 | 45 |
| dispersant | 30 | 15 | 20 | 30 | 40 | 45 |
| Compound | — | 8 | 10 | 15 | 20 | 25 |
| represented by | | | | | | |
| Formula 3 | | | | | | |
| Compound | — | 8 | 10 | 15 | 20 | 25 |
| represented by | | | | | | |
| Formula 4 | | | | | | |

(Unit: parts by weight)

### Experiment Example 1

Adhesion and corrosion prevention effect experiment of anti-corrosion coating layer

A coating layer was prepared by thermosetting the coating composition of the aforementioned preparing example on an aluminum steel sheet test piece.

1. In an adhesion experiment regarding the adhesion of the coating layer, adhesion was measured according to KS D 6711 for aluminum and aluminum alloy painted plates and mats, a case where the coating surface was completely peeled off was set as 0, and a case where the coating surface was not peeled off at all was set as 10, and the degree of adhesion was evaluated as an index.

The results are shown in Table 2 below

TABLE 2

| | T1 | T2 | T3 | T4 | T5 | T6 |
|---|---|---|---|---|---|---|
| Adhesion | 3 | 6 | 9 | 9 | 8 | 5 |

(Unit: index)

According to Table 2, it was confirmed that when the coating layer was formed using the anti-corrosion coating composition of the present invention, relatively excellent adhesion was shown, and in particular, it was confirmed that in the case of T3 to T5, adhesion was maximized.

2. Corrosion prevention effect experiment

A corrosion prevention effect experiment was conducted using a salt spray tester of KS D 9502 to determine whether discoloring or color deterioration occurred after 200 hours.

As a comparative example, an experiment in which the coating layer was not formed was conducted, and the results are shown in Table 3 below.

TABLE 3

| | | | | | | | Comparative |
|---|---|---|---|---|---|---|---|
| | T1 | T2 | T3 | T4 | T5 | T6 | Example |
| Corrosion | Δ | Δ | ◯ | ◯ | ◯ | Δ | X |
| resistance | | | | | | | |

In cases where discoloring or color deterioration does not occur: ◯
In cases where discoloring or color deterioration occurs at 5% or less: Δ
In cases where discoloring or color deterioration occurs at 5% or more: X

According to Table 3, it can be confirmed that when the coating layer was included, the corrosion prevention effect was superior to that of the control group, and in particular, in the case of T3 to T5, the corrosion prevention effect was maximized.

According to the present invention, the massage effect can be maximized by allowing protrusions formed on a roller to intensively hit local sites of the facial skin.

In addition, since the roller can be easily removed from a support, there is an advantage that the roller is easily replaced.

In addition, due to a configuration of the protrusions and grooves of the roller, skin friction can be minimized and a load applied to a motor can be minimized.

In addition, the overall size of the product can be reduced by forming a multi-stage gear combination structure in the motor.

Although the present invention has been described with reference to the embodiments illustrated in the drawings, it is merely exemplary, and it is to be understood to those skilled in the art that various modifications and equivalent other embodiments could be made therefrom. Therefore, the technical protection scope of the present invention should be defined only by the claims.

What is claimed is:

1. A face massager comprising:
a main body including a portion formed to be gripped by a user;
a support branched from an upper portion of the main body to be spaced apart at a predetermined distance; and
a roller that is accommodated in the support and is rotatable,
wherein a plurality of protrusions are formed on the roller.

2. The face massager of claim 1, wherein each of the protrusions is formed to extend in a longitudinal direction of the roller and protrudes from an outer surface of the roller.

3. The face massager of claim 2, wherein the plurality of protrusions are formed to be spaced apart at a predetermined distance in a width direction of the roller.

4. The face massager of claim 3, wherein a groove curved toward a center of the roller is formed between a pair of adjacent protrusions.

5. The face massager of claim 4, wherein an end of the protrusion is rounded.

6. The face massager of claim 1, wherein the roller is detachably coupled to the support.

7. The face massager of claim 1, wherein a surface of the roller is made of silicone.

8. The face massager of claim 1, further comprising: inside the main body,
a motor; and
a plurality of gears,
wherein the motor provides power to rotate the roller in place through the plurality of gears.

9. The face massager of claim 8, wherein an end of the protrusion is rounded to reduce a load of the motor by minimizing resistance when the roller rotates.

10. The face massager of claim 8, wherein a groove curved toward a center of the roller is formed between a pair of adjacent protrusions, and the groove has a shape that is curved toward the center of the roller to reduce a load of the motor by minimizing resistance when the roller rotates.
